(19) United States
(12) Patent Application Publication
(10) Pub. No.: US 2018/0153141 A1
(43) Pub. Date: Jun. 7, 2018

(54) ACCESS BEEKEEPER'S VEIL

(71) Applicant: Walter Chapman, Brooklet, GA (US)

(72) Inventor: Walter Chapman, Brooklet, GA (US)

(21) Appl. No.: 15/829,585

(22) Filed: Dec. 1, 2017

Related U.S. Application Data
(60) Provisional application No. 62/429,751, filed on Dec. 3, 2016.

(51) Int. Cl. A01K 55/00; A42B 5/00; A41D 13/00

(52) U.S. Cl. CPC A01K 55/00; A41D 2300/322; A41D 13/001; A42B 5/00

(57) ABSTRACT

To alleviate the problems that exist in the current state of the art, this invention provides a beekeeper's veil with an opening directly over and in front of the face of the wearer, providing fast, easy access through the veil with out the risk or fears mentioned above. The zipper used to open/close the face-covering panel is preferably visible to the beekeeper so that they do not have to rely on “feel” or mirrors. The head-covering portion of the veil does not have to be lifted over the head, but instead opens directly over the face, making it easy to quickly drink water, wipe sweat from the eyes, or smoke a cigarette. This also allows individuals not familiar with beekeeping to lose precious time attempting to give aid.

### REFERENCE TO RELATED APPLICATIONS

This Application claims priority to U.S. Provisional Patent Application Ser. No. 62/429,751, filed Dec. 3, 2106, the entire content of which is incorporated herein by reference.

### FIELD OF THE INVENTION

This invention relates generally to beekeeper apparel and, in particular, to beekeeper's veil with improved access to the wearer's face.

### BACKGROUND OF THE INVENTION

There are several different styles of beekeeping veils on the market, and they tend to provide too much protection or not enough. FIGS. 1-5 illustrate a typical prior art beekeeper jacket 102 and veil 104. Such veils either use drawstrings or, more commonly, attach to the collar of the jacket by way of a 2-way zipper 106. In addition to a front mesh panel covering the face, mesh panels 108 may also be provided for improved peripheral vision. One or more stiffening elements (not visible) are typically provided around the front mesh panel to maintain a shape that does not fall onto the user's face or head.

Once the traditional veil is properly tied or zipped it should be left alone because even a small mistake may allow honey bees to get inside, which may lead to multiple stings. To further prevent this from happening a hook-and-loop flap 110 may be provided over the zippers, hiding the intersection where the zippers overlap and converge below the chin. Properly “suiting up” takes a little while for beginners to become proficient. Having the confidence to step away from a hive and unzip and flip back the veil takes even more practice.

While fully suited up the beekeeper usually wears thick leather gloves, which makes it much more difficult to get things back together properly. As the user cannot see around their neck, they essentially have to “feel their way” during portions of the suiting and unsuiting process. As a result, it may be difficult to quickly return the veil to a sealed condition if needed. This causes the potential for dehydration and heat stroke, because beekeepers wearing hooded jackets in the heat of summer tend to push through with no fluids instead of investing the time, work, and risk of undoing a veil while out working near their bee yards.

Another safety consideration is the risk of anaphylaxis due to stings. A less experienced and panicked beekeeper can loose precious time fighting a veil while trying to take oral antihistamines. Also, first responders or bystanders finding a beekeeper that is unable to help themselves will waste time trying to remove the veil to gain access to the airway for intubation or CPR.

The need remains in the art for a beekeeper's veil that allows for quick and easy access to the wearer's face.

### SUMMARY OF THE INVENTION

To alleviate the problems that exist in the current state of the art, this invention provides a beekeeper's veil with an opening directly over and in front of the face of the wearer, providing fast, easy access through the veil with out the risk or fears mentioned above. The zipper used to open/close the face-covering panel is preferably visible to the beekeeper so that they do not have to rely on “feel” or mirrors. The head-covering portion of the veil does not have to be lifted over the head, but instead opens directly over the face, making it easy to quickly drink water, wipe sweat from the eyes, or smoke a cigarette. This also allows individuals not familiar with beekeeping to lose precious time attempting to give aid.

A veil according to the invention includes a head-covering portion made from a flexible bee-impermeable material having a bottom opening with a peripheral edge adapted for engagement with a beekeeper jacket or suit. The head-covering portion includes a front portion with a face-covering panel made from a flexible bee-impermeable mesh material, and wherein the face-covering mesh panel attaches to the front portion of the head-covering portion through a zipper, thereby enabling the face-covering mesh panel to be unzipped from the head-covering portion and folded down for access to the wearer's face.

In accordance with a preferred embodiment, the face-covering mesh panel is attached to the front portion of the head-covering portion through a bottom, generally horizontal hinge having two opposing ends, and the zipper is a semi-circular zipper extending from one end of the hinge to the other. The semi-circular zipper may be a two-way zipper (i.e., with two sliders with pull tabs) enabling the front to open or close from either end. The bottom of the face-covering mesh panel may be integrally formed with the material of the head-covering portion such that the hinge is a living hinge.

A structural element to keep the face-covering mesh panel spaced-apart and away from the wearer's face. In one embodiment the structural element comprises one or more semi-circular stiffening members attached to the head-covering portion around the face-covering mesh panel. In accordance with an alternative embodiment the structural element is a hat with a brim.

The peripheral edge of the bottom opening of the head-covering portion is configured for attachment to a beekeeper jacket or suit, with a zipper for example. A bee-impermeable panel may be provided to cover at least a portion of the zipper for added security. One or more curved mesh panels may be provided on the head-covering portion around and behind the face-covering mesh panel the to enhance peripheral vision.

### BRIEF DESCRIPTION OF THE DRAWINGS

FIG. 1 is a front view of a person wearing a beekeeper's jacket and a prior art, unfastened veil, which is not visible in this picture;

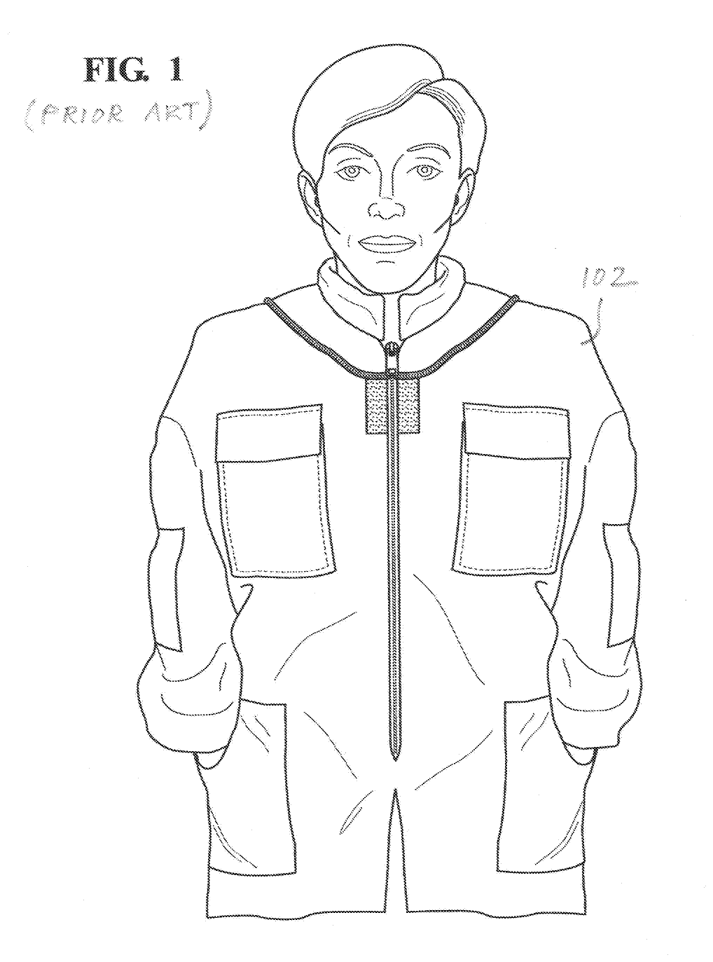

FIG. 2 is a side view of the person showing the unfastened veil draped over their back;

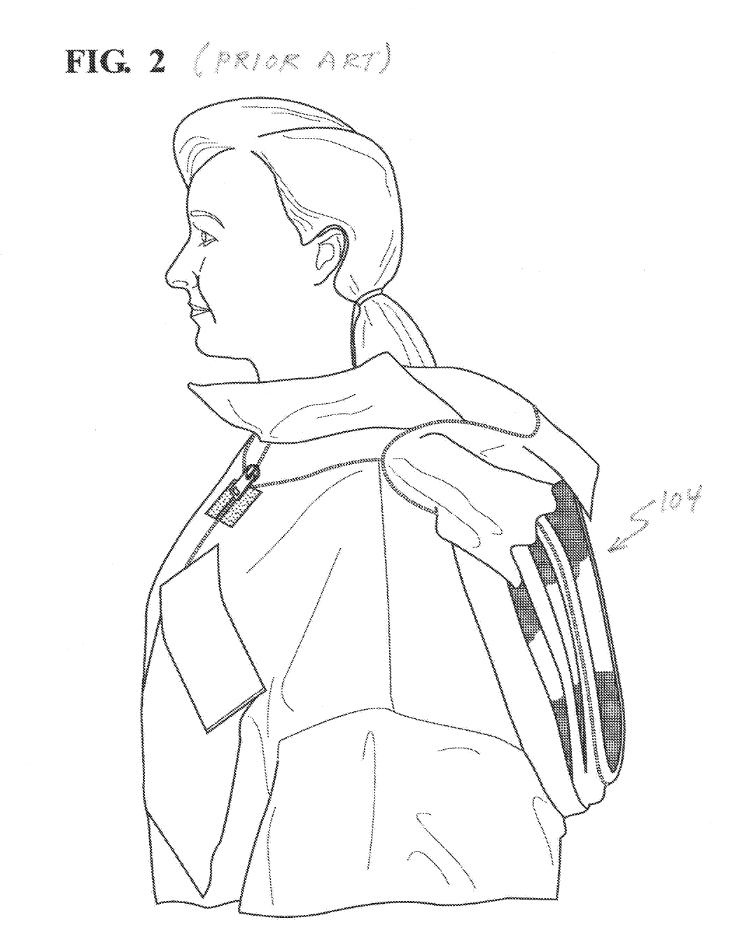

FIG. 3 is a side view of the person showing the veil pulled about halfway over the wearer's head;

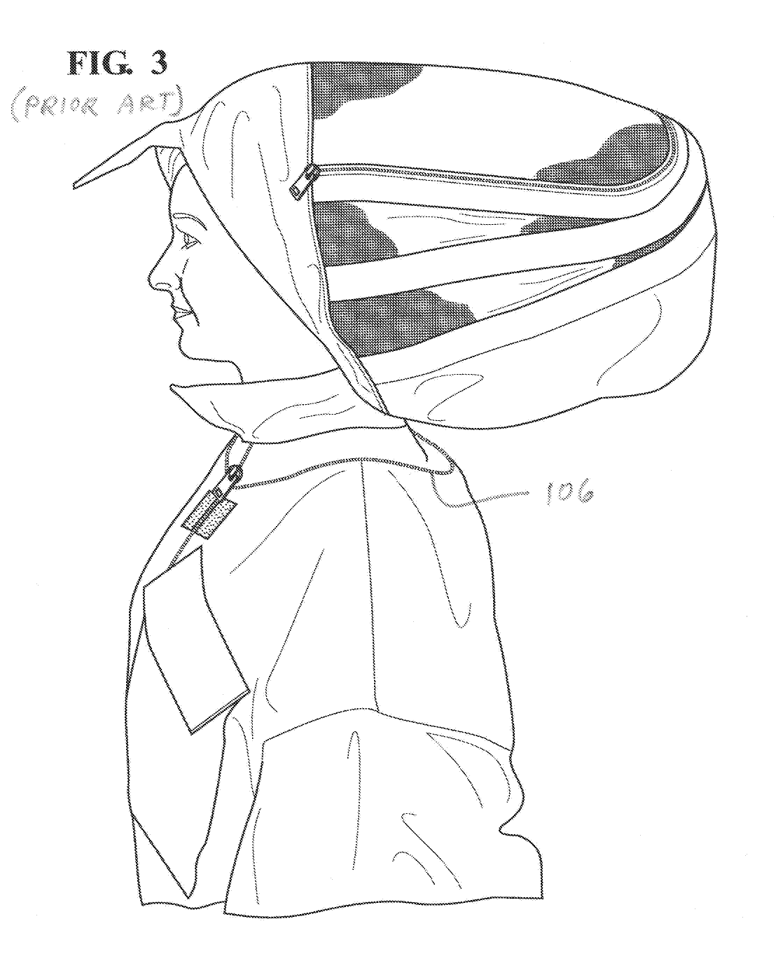

FIG. 4 is a side view showing the veil fully zipped to the wearer's jacket;

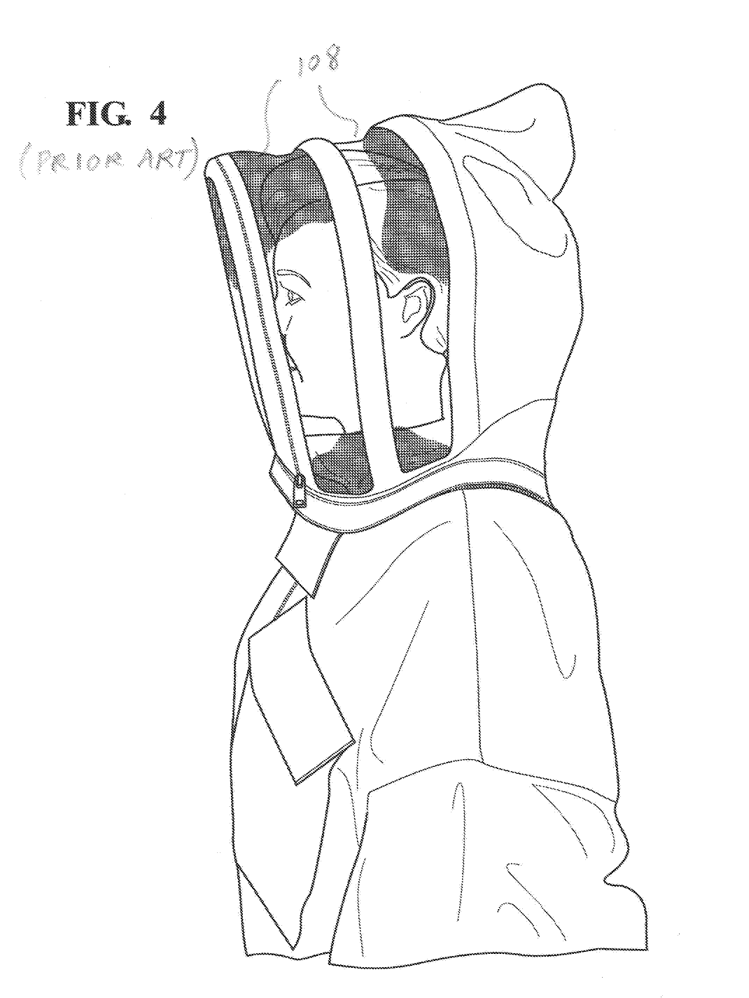

FIG. 5 is a front view of the wearer showing a small flap that covers the zippers of the veil and jacket for added protection;

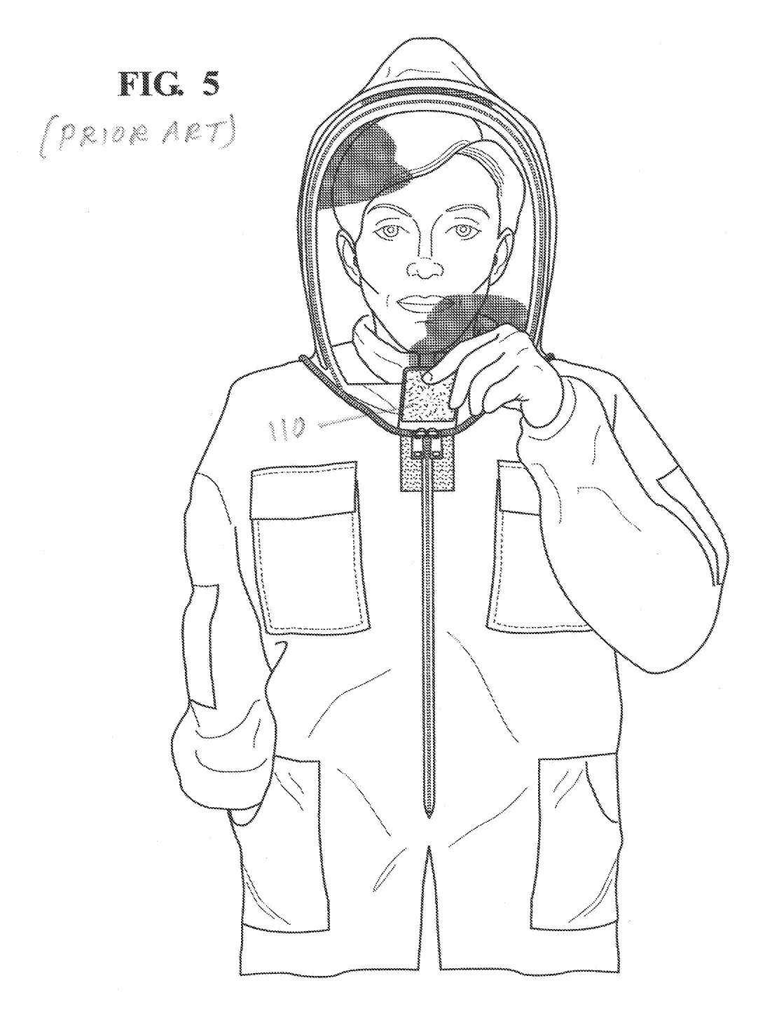

FIG. 6 is a front view of a preferred embodiment of the invention showing an improved beekeeper's veil with a front opening facilitating access to the wearer's entire face;

FIG. 7 is a front view of the embodiment of FIG. 6 with the front access panel fully zipped-up;

FIG. 8 is a front view of an alternative embodiment of the invention including a hat portion; and

FIG. 9 is a front view of the embodiment of FIG. 8 with the front access panel fully zipped-up.

### DETAILED DESCRIPTION OF THE PREFERRED EMBODIMENTS

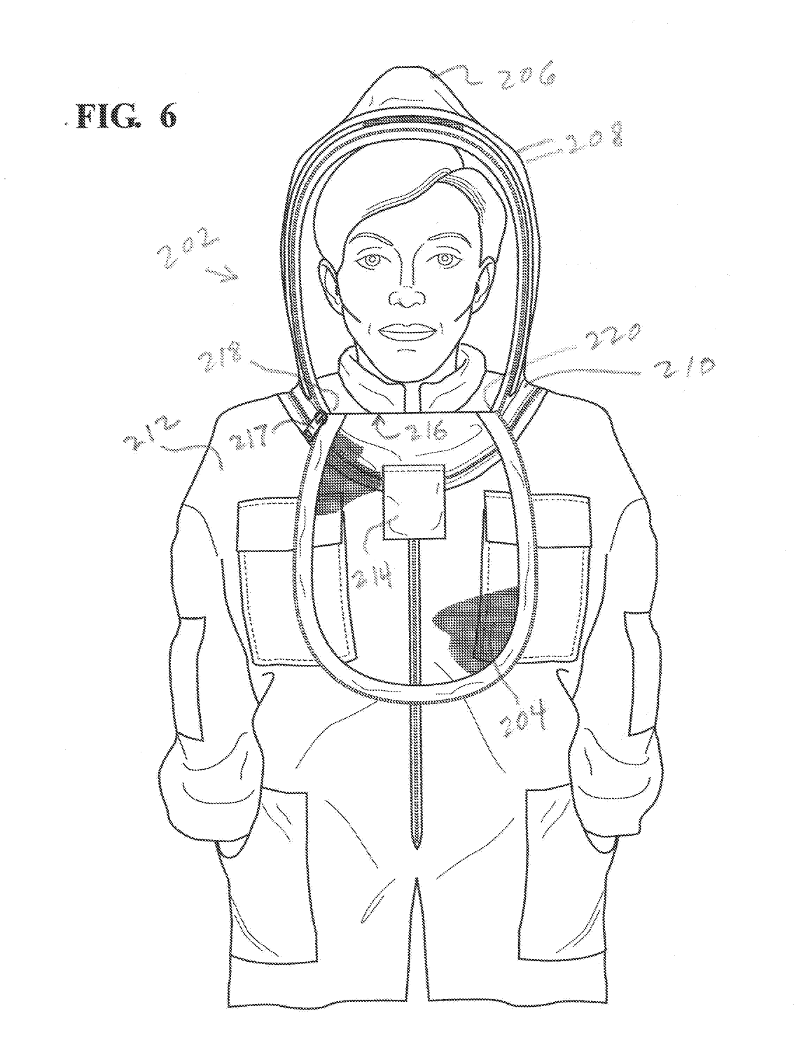

Having discussed he prior art in the Background of the Invention, FIG. 6 is a front view of a preferred embodiment of the invention showing an improved beekeeper's veil 202 with a zippered, front mesh panel 204 that provides fast and easy access to the wearer's entire face. The veil includes a head-covering portion 206 with one or more sewn-in curved stiffening members (not visible) to maintain a generally oval shape in front of the user's face. As with traditional veils, one of more side mesh panels 208 may be provided to enhance peripheral vision. The curved stiffening member(s) may be positioned on one or more sides of these peripheral mesh bands 208.

The bottom edge 210 of the head-covering portion 206 may be connected to the jacket 212 using and suitable fasteners, though one or more zippers are preferred. Flap 214 may be provided to cover the zipper end(s). As a further alternative, if enough extra material is provided along the bottom of the head-covering portion, the veil may not even require attachment to the jacket.

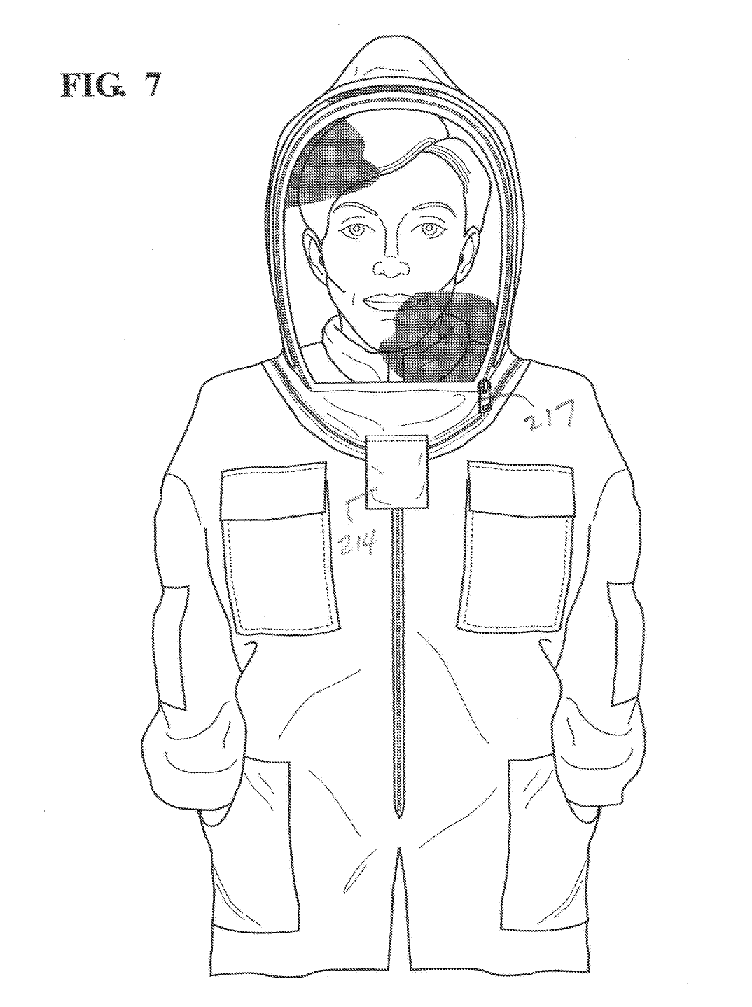

The front mesh panel 204 may be permanently connected or integrally formed with the material of the head-covering portion 206 along line 216, thereby providing a hinge or living hinge. The remaining peripheral edge of front mesh panel connects to the head-covering portion through a zipper 217, preferably a two-way zipper enabling the front to open or close from either corner 218, 220. The zipper is preferably visible from inside the veil, thereby making it easier for the wearer to find and open/close the same. FIG. 7 shows the veil with the front mesh panel in a closed condition.

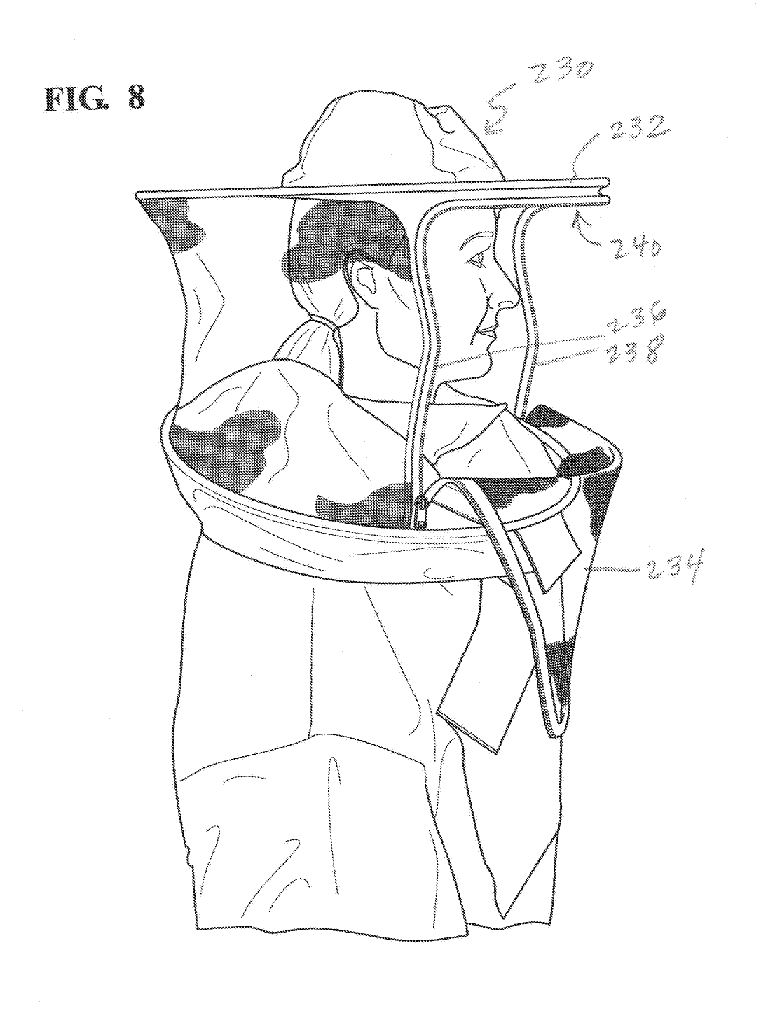

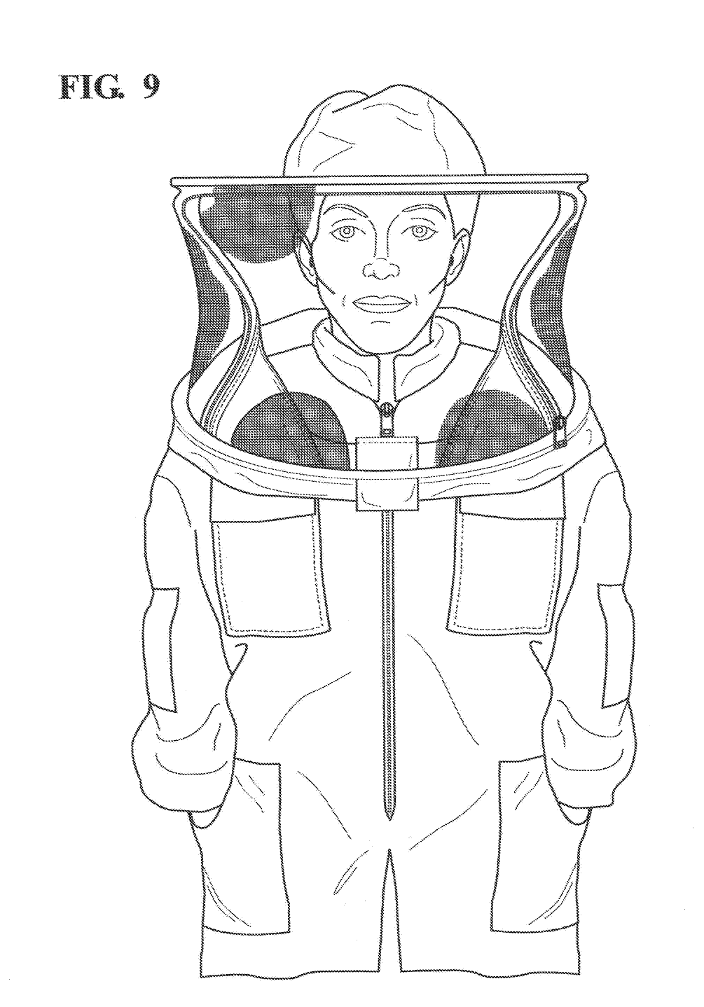

FIG. 8 is a front view of an alternative embodiment of the invention including a hat portion 230 with a peripheral brim 232. In this embodiment the front mesh face-covering panel 234 zips along two opposing generally vertical tracks 236, 238, but with the upper portion following along the outer edge of the brim at 240. FIG. 9 is a front view of the embodiment of FIG. 8 with the front access panel fully zipped-up.

The round veil of FIGS. 8, 9 may also have separate vertical zippers on either side of the face to allow access as opposed to the vertical openings being connected across the top of the brim using a single or two-way zipper to create a panel that opens.

In all embodiments, the veil can be made of cotton, cotton/polyester, or a 3-layer mesh with nylon inner and outer layers with polyurethane spacer material. The mesh may be any bee-impenetrable material, including 8-mesh hardware cloth or other materials known in the industry.

1. A beekeeper's veil with improved facial access, comprising:
a head-covering portion made from a flexible bee-impenetrable material having a bottom opening with a peripheral edge adapted for engagement with a beekeeper jacket or suit;
the head-covering portion including a front portion with a face-covering panel made from a flexible bee-impenetrable mesh material; and
wherein the face-covering mesh panel attaches to the front portion of the head-covering portion through a zipper, thereby enabling the face-covering mesh panel to be unzipped from the head-covering portion and folded down for access to the wearer's face.

2. The beekeeper's veil of claim 1, wherein:
the face-covering mesh panel is attached to the front portion of the head-covering portion through a bottom, generally horizontal hinge having two opposing ends; and
wherein the zipper is a semi-circular zipper extending from one end of the hinge to the other.

3. The beekeeper's veil of claim 2, wherein the semi-circular zipper is a two-way zipper enabling the front to open or close from either end.

4. The beekeeper's veil of claim 2, wherein the bottom of the face-covering mesh panel in integrally formed with the material of the head-covering portion such that the hinge is a living hinge.

5. The beekeeper's veil of claim 1, including a structural element to keep the face-covering mesh panel spaced-apart and away from the wearer's face.

6. The beekeeper's veil of claim 5, wherein the structural element is a semi-circular stiffening member attached to the head-covering portion around the face-covering mesh panel.

7. The beekeeper's veil of claim 5, wherein the structural element is a hat with a brim.

8. The beekeeper's veil of claim 1, wherein the peripheral edge of the bottom opening of the head-covering portion is adapted for attachment to a beekeeper jacket or suit.

9. The beekeeper's veil of claim 1, wherein the peripheral edge of the bottom opening of the head-covering portion is adapted to attach to a beekeeper jacket or suit with a zipper.

10. The beekeeper's veil of claim 9, further including a bee-impermeable panel to cover at least a portion of the zipper.

11. The beekeeper's veil of claim 1, further including one or more mesh panels on the head-covering portion to enhance peripheral vision.
